(19) United States
(12) Patent Application Publication
(10) Pub. No.: US 2004/0169007 A1
(43) Pub. Date: Sep. 2, 2004

(54) Template-assisted nanostructure formation

(76) Inventors: Melissa Sander, Singapore (SG); Le-Shon Tan, Singapore (SG)

Correspondence Address: Killworth, Gottman,, Hagan & Schaeff, L.L.P., Suite 500, One Dayton Centre, Dayton, OH, 45402-2023, US

(21) Appl. No.: 10/376,583

(22) Filed: Feb. 28, 2003

(51) Int. Cl. B44C 1/22

(52) U.S. Cl. 216/33

(57) ABSTRACT

A template is provided on a substrate with a pattern of nanoscale pores extending through to the substrate. The template may be, for example, porous anodic alumina. Self-assembling molecules are then introduced to the template, such as by immersing a template in a solution of these molecules. The self-assembling molecules have a bonding group that will bond with the substrate. The result is that the self-assembling molecules, possibly after being triggered to self-assemble, assemble to form nanoscale islands in the pores. Optionally, thereafter the template may be stripped from the substrate.

This invention relates to a method of forming a nanostructure on a substrate and to nanostructures.

The emerging field of nanotechnology holds promise for a variety of applications such as molecular scale electronics, information storage, and sensing arrays.

A number of different techniques have been used to form nanostructures on a substrate. One such technique is nanolithography. In electron beam or molecular beam nanolithography, electrons or molecules may be used to pattern a resist layer such as self-assembled monolayers (SAMs) on a substrate. In scanning probe lithography a “writing” tip may be used to pattern a resist layer or may be dipped into a solution to pattern SAMs on a substrate. An exemplary nanolithographic technique is described in US 2002/0063212 to Mirkin et al. published May 30, 2002.

Nanoscale patterns wherein the dimensions of each region (island) are relatively large (greater than about 100 nm) may be formed on a substrate with microcontact printing, such as is described in U.S. Pat. No. 5,512,131 to Kumar et al. With microcontact printing, a stamp may have a patterned stamping surface. This surface may be coated with a molecular species terminating at a first end in a bonding group selected to bind to a substrate. The stamping surface may then be brought into contact with the substrate to hold the molecular species against the substrate to allow the bonding group to bind to the surface. Finally, the stamping surface may be removed to provide a SAM of the molecular species on the substrate. A drawback with this approach is that there is a limitation in its resolution due to the diffusion of SAMs during printing. Additionally, it is difficult to pattern large areas reproducibly.

It would be desirable to have an alternative and simple approach to forming nanostructures on a substrate.

### SUMMARY OF INVENTION

A template is provided on a substrate with a pattern of nanoscale pores extending through to the substrate. The template may be, for example, porous anodic alumina. Self-assembling molecules are then introduced to the template, such as by immersing the template in a solution of these molecules. The self-assembling molecules have a bonding group that will bond with the substrate, for example, through a covalent bond. The result is that the self-assembling molecules, possibly after being triggered to self-assemble, assemble to form nanoscale islands in the pores. Optionally, thereafter the template may be stripped from the substrate.

According to the present invention, there is provided a method of forming nanostructures on a substrate, comprising: providing a template on a substrate, the template having a pattern of nanoscale pores extending through to the substrate; introducing self-assembling molecules to the template, the self-assembling molecules having a bonding group that will bond with the substrate whereby the self-assembling molecules may assemble to form nanoscale islands in the pores.

There is also provided a manufacture, comprising: a substrate; a template layer on the substrate with a pattern of nanoscale pores extending through to the substrate; islands within the pores, each island formed of self-assembling molecules chemically bonded to the substrate.

Other features and advantages will become apparent from a review of the following description, in conjunction with the drawings.

### BRIEF DESCRIPTION OF THE DRAWINGS

In the figures which illustrate example embodiments of the invention,

FIG. 1 is a schematic illustration of a substrate and template;

FIG. 2 is a schematic illustration of a substrate and porous template;

FIG. 3 is a schematic illustration of an approach to form nanoscale islands;

FIG. 4 is a schematic illustration of a substrate with nanoscale islands;

FIG. 5 schematically illustrates formation of different nanoscale arrays;

FIG. 6 schematically illustrates an example substrate and bonded self-assembling molecules;

FIG. 7 is an LFM (lateral force microscopy) image of an ODTMS surface.

FIG. 8 is a distance versus voltage graph along the highlighted line of FIG. 7;

FIG. 9 schematically illustrates an example substrate and bonded self-assembling molecules.

### DETAILED DESCRIPTION

As used herein, the-following terms have the following meanings.

“Self-assembling molecules” refers to molecules which spontaneously become ordered, or structured. The order or structure forms spontaneously as a consequence of the nature of the molecules. With some types of self-assembling molecules, the order or structure arises after certain parameters (triggers) reach critical values.

“Bond” means a force of attraction holding atoms or molecules together. It includes both strong bonds (such as a covalent bond) and weak bonds (such as a van der Waals force or an electrostatic force).

“Chemical bond” means a strong force of attraction holding atoms together. It includes ionic, covalent, and hydrogen bonds and other types of bonds. It may be either an intermolecular or an intramolecular force.

“Bonding group” means a group of one or more atoms in a self-assembling molecule responsible for bonding the molecule to a foreign object such as a substrate surface.

In overview, nanoscale structures may be formed on a substrate by applying a template on the substrate with a pattern of nanoscale pores extending through to the substrate. These pores may be provided in the template layer either before or after application of the layer. Self-assembling molecules of a type having a bonding group that will bond with the substrate are then introduced. These self-assembling molecules may then self-assemble as nanoscale islands in the pores of the template.

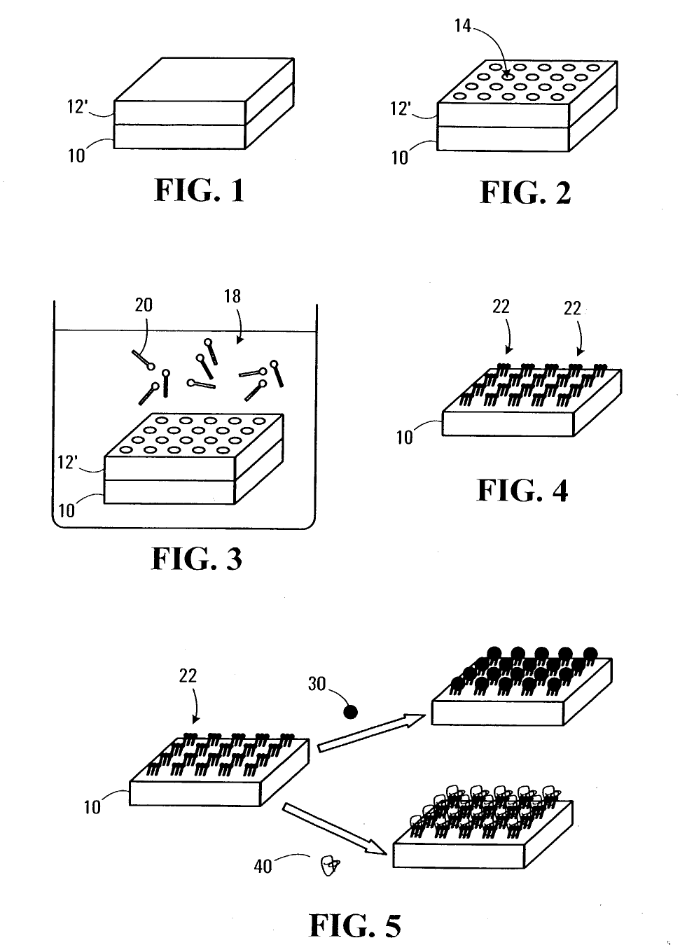

FIG. 1 illustrates a substrate 10 to which an aluminum layer 12 has been applied. The aluminum layer may be evaporated onto the substrate to a thickness of one to two microns (or more). In a manner known to those skilled in the art, the aluminum layer may be anodized so that it becomes a porous alumina (Al₂O₃) layer. As illustrated in FIG. 2, the pores 14 of the alumina layer 12′ are parallel, dense, of nearly uniform diameter, and extend across the layer. The aluminum layer may be anodized by, for example, immersing the layer in a 0.2 M sulfuric acid and applying a potential difference of twenty-five volts. Or it may be anodized by immersion in a 0.3 M oxalic acid and applying a potential difference of forty volts. As a further example, the layer may be anodized by immersion in a 0.3 M phosphoric acid and applying a potential difference of 150 volts. Further details of the process for anodizing an aluminum layer may be found in, for example, “Self-organized formation of hexagonal pore arrays in anodic alumina,” Jessensky, O., Muller, F., and Gosele, U., Applied Physics Letters (1998) 72, 1173. As will be appreciated by those skilled in the art, the pore diameter depends upon the anodization conditions and can be further tuned with a chemical etching step (as, for example, by etching with 5% by weight H₃PO₄). As will be appreciated by those skilled in the art, pore diameters of about fifteen nanometers to over 400 nanometers may be achieved. After complete anodization, there will normally be a thin barrier of alumina at the base of the pores that is removed by a short chemical etching step (which also causes a slight pore widening). As will also be appreciated by those skilled in the art, pore height is also tunable from about 0.1 micron to 1 micron or greater.

As will be appreciated by those skilled in the art, as an alternative to forming a template (of anodic alumina) by anodizing aluminum, a suitable template may be formed from self-assembling diblock copolymers or using colloidal lithography or other techniques.

After formation of the through pores in the template layer, a liquid solution of self-assembling molecules may be deposited on the template. As illustrated in FIG. 3, this may be accomplished by immersing the substrate and template in a solution 18 of self-assembling molecules 20. With an appropriate choice of self-assembling molecules and substrate, the self-assembling molecules will bond, e.g. chemically bond, to the substrate in the pores of the template in order to form nanoscale islands in the pores. Thereafter, the template may be stripped off, leaving the nanoscale islands 22, as illustrated in FIG. 4.

There are various suitable combinations of substrate and self-assembling molecules. Some exemplary self-assembling molecules are listed below with corresponding suitable substrates:

| Substrate | Self-Assembling Molecule |
|---|---|
| GaAs, InP | R₁SH |
| Al, Si, Cu, Pt | R₁COOH |
| Si, SiO₂, glass | Organosilanes, such as R₁SiCl₃ and |
| | R₁Si(OR₂)₃; (R₁COO)₂; |
| | R₁CH═CH₂; R₁Li; R₁MgX |
| Au | R₁SH, ArSH, R₁SSR₂, R₁SR₂, |
| | R₁SO₂H, (R₁)₃P, R₁NC, R₁CN, |
| | (R₁)₃N, R₁COOH, |
| Ag, Cu, Pt, semiconductor | R₁SH, (R₁)₃N, ArSH |
| Ag, Au, Si, glass, and | Proteins, peptides |
| polystyrene | |
| Pt | R₁NC, R₁SH, R₁SSR₂, R₁SR₂ |
| Metal oxide | R₁COOH, R₁CONHR₂ |
| Cuprate high temperature | R₁SH, R₁NH₂, ArNH₂, |
| superconductors | pyrrole, pyrrole derivatives wherein R₁ |
| | is attached to one of the |
| | carbons of the pyrrole ring |
| ZrO₂, In₂O₃/SnO₂ | R₁PO₃H₂ |
| Si | azoalkanes (R₃NNR₃), isothiocyanates |
| | (R₃NCS), olefins, |
| | dienes |
| SiO₂, oxidized GaAs | Silazanes |

In the above table:

R₁ and R₂ each has the formula X(CH₂)ₙ and, if a molecule comprises both R₁ and

R₂, then R₁ and R₂ can be the same or different;

R₃ has the formula CH₃(CH₂)ₙ;

n is 0-30;

Ar is an aryl;

X is —CH₃, —CHCH₃, —COOH, —CO₂(CH₂)ₘCH₃, —OH, —CH₂OH, ethylene glycol, hexa(ethylene glycol), —O(CH₂)ₘCH₃, —NH₂, —NH(CH₂)ₘNH₂, halogen, glucose, maltose, fullerene C60, a nucleic acid (oligonucleotide, DNA, RNA, etc.), a protein (e.g., an antibody or enzyme), or a ligand (e.g., an antigen, enzyme substrate or receptor); and

m is 0-30.

As will be appreciated, the bonding group can comprise a functional group of the self-assembling molecule. As will be appreciated from the above table, and as further illustrated in FIGS. 5, 6, and 9, the bonding group can comprise an end group. In addition to the bonding group, the self-assembling molecule may have a terminal functional group, which is an end group of the molecule that remains exposed when the molecule has bonded with the substrate surface. The terminal group may adapt the nanoscale islands for a particular use or may serve as a foundation to attach to other structures which adapt the nanoscale islands for a particular use. For example, a terminal group may be one of alkene groups, alkyl groups, alkane groups, aryl groups, amino groups, thiol groups, carboxyl groups, hydroxyl groups, ethylene glycols, halogens, glucoses, maltoses, fullerenes, nucleic acids, proteins, and ligands.

The choice of the terminal group may depend on the use of the nanostructure. For example, as illustrated in FIG. 5, the terminal group may allow the attachment of nanoparticles 30 to the islands 22 so that they are adapted for sensing, information storage, an optoelectronics function, or a microelectronics function. Alternatively, the terminal group may allow the attachment of biomolecules 40 to provide a biocompatible interface, for example to allow cell-substrate adhesion.

In a self-assembling molecule that has both a bonding group and a terminal group, the terminal group may bond directly to the bonding group, or may be connected to the bonding group through one or more intermediate functional groups. An intermediate functional group may be desirable, such as when a separation between the bonding group and the terminal group is desirable. Or an intermediate functional group may be necessary, such as when the bonding and the terminal groups do not bond directly.

Additional substrate and self-assembling molecule combinations are described in US 2002/0063212 to Mirkin et al. Some exemplary combinations of substrates and self-assembling molecules are described in more detail below.

One choice of substrate is a silicon wafer with a silicon dioxide surface layer, the surface layer being that which the template abuts. The silicon may be either n-type or p-type, and the surface layer may be a native, or grown, oxide layer. There are a number of ways to grow a layer of silicon dioxide. In one method, the native oxide layer is first stripped with a buffered oxide etch (BOE)—applied for about five minutes, then the wafer is immersed in 70% Nitric acid (HNO₃) for about five minutes at 115° C.

With such a substrate, the self-assembling molecules may be molecules with a bonding group that is a silane. These self-assembling molecules will covalently bond to the silicon dioxide surface layer of the substrate. More particularly, the silicon substrate and template may be placed in a solution of these self-assembling molecules for a few minutes to several days (depending on the system) so that the molecules assemble and covalently bond to the exposed silicon dioxide surface in the pores of the template to form nanoscale islands. Thereafter, the template layer may be removed by, for example, using adhesive tape.

Other self-assembling molecules may also be used with a silicon dioxide surface. For example, silazanes or molecules having a bonding group that is an alkene may be used.

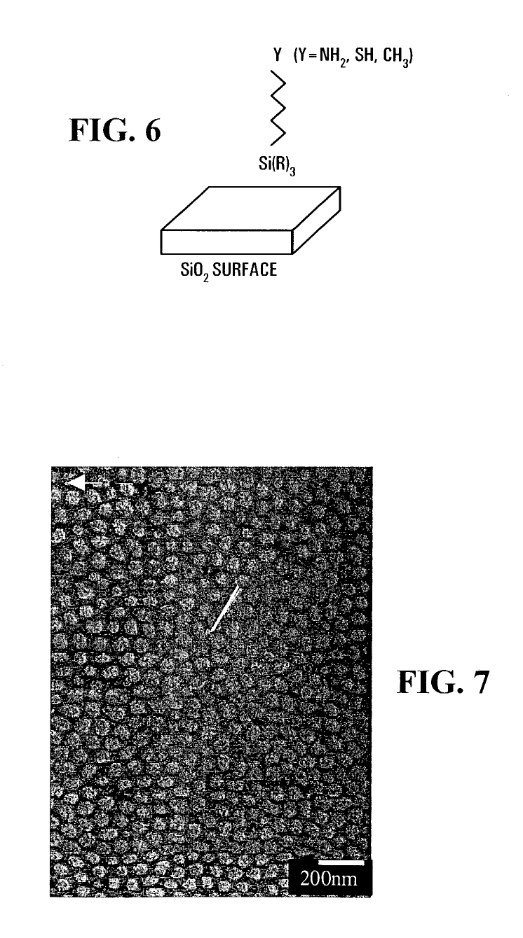

An example of a self-assembled molecule bonded to a silicon dioxide surface is schematically illustrated in FIG. 6. As illustrated, the bonding group is a silane and the terminal group is one of an amine, thiol, or methyl.

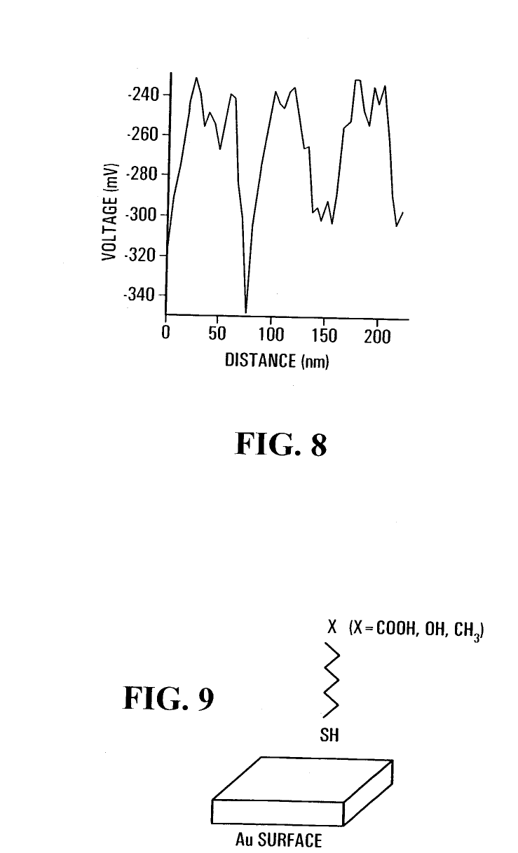

As a more specific example, the self-assembling molecules may be amino or alkyl terminated methoxysilanes. Indeed, the foregoing technique has been demonstrated for a silicon substrate with a silicon dioxide surface layer and a porous alumina template using aminopropyltrimethoxysilane (APTMS) and octadecyltrimethoxysilane (ODTMS) as the self-assembling molecules. FIG. 7 shows an LFM image of the ODTMS islands formed on a substrate. The line scan of FIG. 8 shows a distance versus voltage graph for the highlighted region of FIG. 7. The voltage varies with the change in friction between the surface and a probing tip and is thus correlated to the variation in surface height.

Another choice of substrate is one that has a passivated silicon surface. For example, the silicon surface may be a hydrogen terminated surface, which may be produced after first removing the native oxide (with a chemical etch). The silicon may be n-type or p-type. With such a substrate, the self-assembling molecules may be molecules with a bonding group that is an unsaturated hydrocarbon group, such as an olefin or diene. An example of a terminal group that may be present in such a self-assembling molecule is a carboxyl group.

A further choice of substrate is one having a gold surface. This may be obtained by evaporating an adhesion layer on a (n-type or p-type) silicon wafer, such as a five nanometer titanium layer, followed by the desired surface layer, for example a twenty nanometer gold layer.

For a substrate with a gold surface, suitable self-assembling molecules include molecules that have a bonding group that is a sulphur-containing group (such as a thiol, thiolate, sulphide, disulphide, or the like). As illustrated in FIG. 9, on a gold surface, the self-assembling molecule may have a bonding group that is a thiol and may have a terminal functional group such as a carboxyl, hydroxyl, or methyl group.

Substrates made of aluminum, gallium arsenide, or titanium oxide may also be used with self-assembling molecules that have a sulphur-containing functional group, such as a thiol, as the bonding group.

With certain substrates, such as a gold, silver, glass, silicon, or polystyrene substrate, the suitable self-assembling molecules may comprise peptides such as proteins.

The self-assembling molecules may also include suitably terminated cellular structures.

Some of the above described self-assembling molecules self-assemble at room temperature given sufficient time. Those skilled in the art will recognise that other substrate and self-assembling molecule combinations may need triggers for the self-assembling molecules to self-assemble. Further, it will be appreciated that it is not necessary that the self-assembling molecules form a covalent bond with the substrate. Instead, any chemical bond may suffice. In appropriate applications, such as when the desired or allowable degree of bonding stability is low, it may be sufficient that the self-assembling molecules only form weak bonds with the substrate, such as a van der Waals bond.

It will also be appreciated that since the self-assembling molecules need to reach the substrate surface, self-assembling molecules that, due to their size, cannot fit into the pores of the template are not suitable.

Other modifications will be apparent to those skilled in the art and, therefore, the invention is defined in the claims.

What is claimed is:

1. A method of forming nanostructures on a substrate, comprising:
providing a template on a substrate, said template having a pattern of nanoscale pores extending through to said substrate;
introducing self-assembling molecules to said template, said self-assembling molecules having a bonding group that will bond with said substrate whereby said self-assembling molecules may assemble to form nanoscale islands in said pores.

2. The method of claim 1, wherein said bonding group will chemically bond with said substrate.

3. The method of claim 2 wherein said bonding group will covalently bond with said substrate.

4. The method of claim 2 wherein said providing said template comprises applying a layer to said substrate.

5. The method of claim 4 wherein said applying comprises evaporating said layer onto said substrate.

6. The method of claim 4 further comprising forming said pattern of pores through said template layer after applying said layer to said substrate.

7. The method of claim 6 wherein said layer is aluminum and said through pores are formed by anodization of said aluminum layer followed by chemical etching.

8. The method of claim 2 wherein said template is porous anodic aluminum oxide.

9. The method of claim 2 wherein said introducing comprises introducing a liquid solution of said self-assembling molecules onto said template.

10. The method of claim 2 further comprising triggering said self-assembling molecules to self-assemble.

11. The method of claim 10 wherein said triggering comprises varying temperature.

12. The method of claim 2 wherein each of said self-assembling molecules has a terminal functional group.

13. The method of claim 12 wherein said terminal functional group is selected from the class of alkene groups, alkyl groups, alkane groups, aryl groups, amino groups, thiol groups, carboxyl groups, hydroxyl groups, ethylene glycols, halogens, glucoses, maltoses, fullerenes, nucleic acids, proteins, and ligands.

14. The method of claim 12 wherein said substrate has a silicon surface abutting said template.

15. The method of claim 14 wherein said bonding group is an alkene or a silane.

16. The method of claim 12 wherein said substrate has a silicon dioxide surface layer abutting said template.

17. The method of claim 16 wherein said bonding group is a silane

18. The method of claim 17 wherein said terminal functional group is selected from the class of amino groups, thiol groups, and alkyl groups.

19. The method of claim 18, wherein said self-assembling molecules are one of amino or alkyl terminated methoxysilanes.

20. The method of claim 12 wherein said substrate has a surface layer abutting said template chosen from the class of aluminum, gallium arsenide, and titanium oxide.

21. The method of claim 20 wherein said bonding is an alkyl group or a sulphur-containing group.

22. The method of claim 12, wherein said substrate has a gold surface layer abutting said template.

23. The method of claim 22 wherein said bonding group is a sulphur-containing group.

24. The method of claim 2 wherein said substrate has a surface layer abutting said template chosen from the class of gold and silicon, and said self-assembling molecule is a peptide.

25. The method of claim 24 wherein said peptide is a protein.

26. The method of claim 1 further comprising, after said self-assembling molecules have assembled to form nanoscale islands in said pores, removing said template from said substrate.

27. A manufacture, comprising:
a substrate;
a template layer on said substrate with a pattern of nanoscale pores extending through to said substrate;
islands within said pores, each island formed of self-assembling molecules chemically bonded to said substrate.
